(19) United States
(12) Patent Application Publication
(10) Pub. No.: US 2015/0222125 A1
(43) Pub. Date: Aug. 6, 2015

(54) CONNECTOR WITH LOAD CIRCUIT

(71) Applicant: Molex Incorporated, Lisle, IL (US)

(72) Inventor: David L. Brunker, Naperville, IL (US)

(73) Assignee: Molex Incorporated, Lisle, IL (US)

(21) Appl. No.: 14/409,695

(22) PCT Filed: Jun. 19, 2013
(86) PCT No.: PCT/US13/46598

§ 371 Date: Dec. 19, 2014

Related U.S. Application Data
(60) Provisional application No. 61/662,678, filed on Jun. 21, 2012.

(51) Int. Cl. H02J 5/00; H02J 3/02

(52) U.S. Cl. CPC H02J 5/00; H02J 3/02

(57) ABSTRACT

An Ethernet port is configured with a load circuit that reduces costs compared to the conventional Bob-Smith load circuit when providing Power Over Ethernet (POE). A first centertap from a first transformer is coupled to a first side of a first capacitor. A second centertap from a second transformer is coupled to a first side of a second capacitor. The second side of the first and second capacitors is coupled to a common node. The common node forms an electrical midpoint between the two centertaps. An avalanche diode can be placed between the two centertaps in parallel with the two series connected capacitors and power can be injected on the two centertaps to provide POE. A single resistor can be used to provide load termination before a safety capacitor.

### RELATED APPLICATIONS

This application claims priority to U.S. Provisional Application No. 61/662,678, filed Jun. 21, 2012 which is incorporated herein by reference in its entirety.

### FIELD OF THE INVENTION

The present invention relates to field of connectors suitable for use with magnetics, more specifically connectors suitable for use with Ethernet ports.

### DESCRIPTION OF RELATED ART

The Bob Smith load circuit (so name because the inventor was Mr. Robert Smith) was originally developed in 1983 as a way to handle termination of an Ethernet-based connection between a plug and a port. Such ports are commonly referred to as RJ45 connectors (technically this connector can more accurately be referred to as an 8P8C connector but due to popular usage the term RJ45 will be used herein). In order to provide electrical isolation, among other benefits, a transformer was used to magnetically couple two contacts on one side of the transformer (primary) to two contacts on the other side (secondary), resulting in an electrical output from the transformer. Originally there were two pairs of contacts that provided signals (for 10/100 based Ethernet). The Bob-Smith load circuit introduced the concept of having a balanced termination by having each centertap, derived from the wires wound around each transformer, to be electrically connected to a resistor and the resistors all coupled to a common node, which could then be coupled to ground, While this circuit was originally disclosed without showing the receptacle, a person of skill in the art would understand the load circuit was to be included in a receptacle (e.g., where the transformer was located).

While the Bob Smith load circuit has been considered somewhat standard in the industry since its conception, the load circuit was designed prior to the implementation of Power Over Ethernet (“POE”). POE functions by placing a DC voltage across the center taps of two pairs (this is repeated for the second set of two pairs with the double power for a Universal Power Over Ethernet (UPOE) configuration) on the primary side of the transformer. The DC voltage difference (which is typically 48 volts) does not affect the signals provided within a given pair as the applied DC voltage essentially just raises the common mode voltage floor within a given pair about which the differential signaling voltage fluctuates. However, it is necessary to ensure the system can safely inject the power onto the data pairs. To obtain suitable functionality, a typical implementation of a load-circuit that includes POE is disclosed in FIG. 1. As can be appreciated, transformers 15 are provided to magnetically couple contacts on a first side 16 of the transformer 15 to contacts on a second side 17 of the transformer 15. A centertap 18 from each transformer is connected to a capacitor 25, which provides a DC blocking function to eliminate DC current flow through the appending AC load circuit, ensuring electrical separation between both sides of the pairs and the AC load. The capacitor 25 is then coupled to a resistor 30 and in a system where there are four resistors, each of the resistors is electrically connected to a common node 32. From there the safety capacitor 35 (which is a standard feature in circuits that help provide the necessary electrical isolation to allow the part to be considered safe) connects the load to ground 10 (which can be a shield or any desirable structure that is coupled the reference voltage plane).

The Power Over Ethernet (POE) circuit injects power on to pairs by creating a DC voltage between pair 19a and pair 19b, A capacitor 40 provides electrical separation between the pairs and an avalanche diode 45 provides for a current shunt in the event of an overvoltage event. Given the volume of POE ports that are sold, a circuit that could reduce costs while providing suitable performance would be appreciated by certain individuals.

### BRIEF SUMMARY

A load circuit is provided that includes a first and second transformers, each transformer used to magnetically couple a first and second contact on a first side of the transformer to a third and fourth contact on a second side of the transformer. A first centertap from the first transformer is coupled to a first side of a first capacitor. A second centertap from the second transformer is coupled to a first side of a second capacitor. The second side of the first and second capacitors is coupled to a common node. The common node forms an electrical midpoint between the two centertaps. An avalanche diode (or electrical equivalent) can be placed between the two centertaps in parallel with the two series connected capacitors. A single resistor can be used to provide load termination before a safety capacitor.

### BRIEF DESCRIPTION OF THE DRAWINGS

The present invention is illustrated by way of example and not limited in the accompanying figures in which like reference numerals indicate similar elements and in which:

FIG. 1 illustrates a schematic of a prior art load circuit suitable for use in a Power Over Ethernet (POE) application.

FIG. 2 illustrates an additional feature of the load circuit depicted in FIG. 1.

FIG. 3 illustrates a schematic of a load circuit suitable for use in a POE application.

FIG. 4 illustrates another schematic of a load circuit suitable tot use in a POE application or a non-POE application.

FIG. 5 illustrates a schematic representation of an Ethernet port.

FIG. 6 illustrates a block diagram of an Ethernet port.

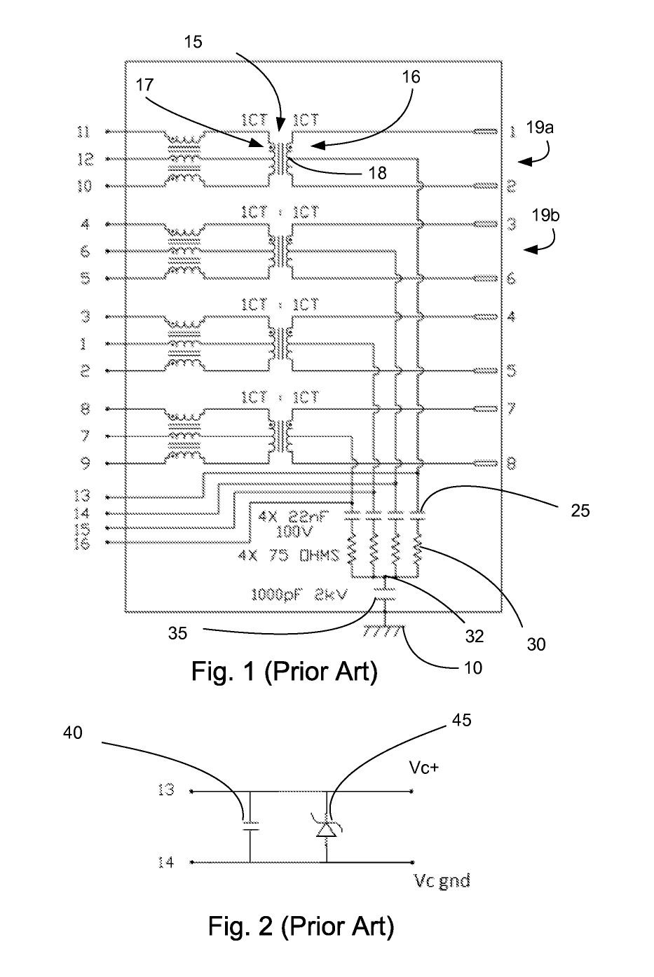

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

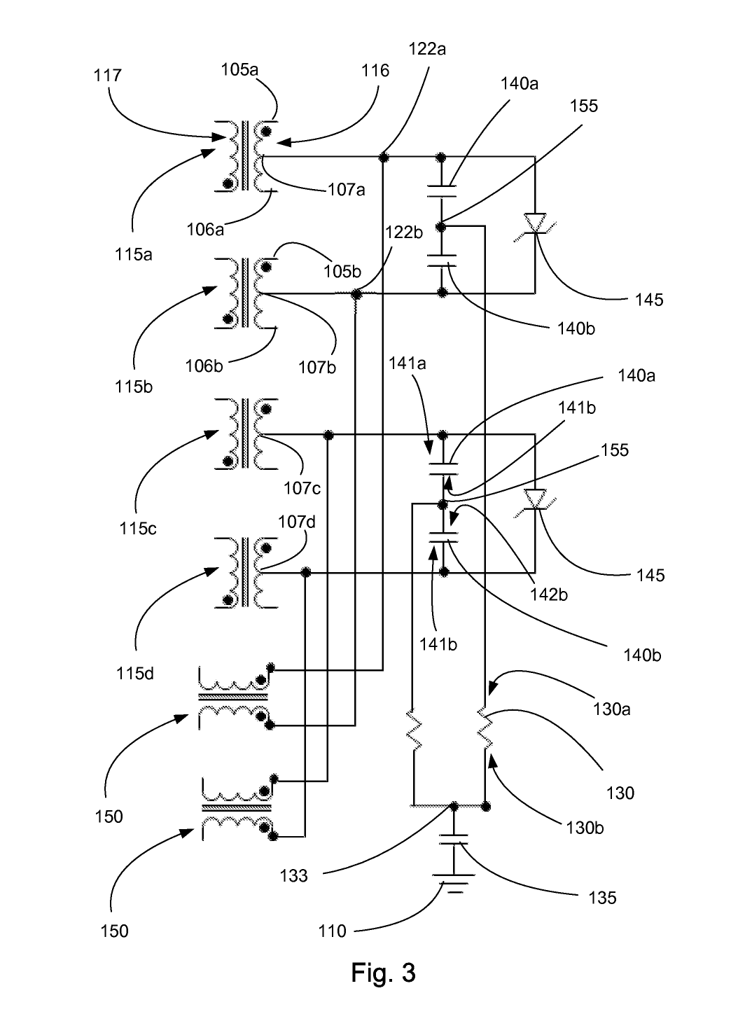

FIG. 3 illustrates a schematic of a circuit suitable for use in a connector. The circuit includes a plurality of transformers 115a-115d that each include a first side 116 and a second side 117. As is typical, the first side and second side are magnetically coupled together by having wires wound around the transformer so as to magnetically couple the first wire to the second wire while providing electrical separation between the two wires. Thus, the first side 116 is magnetically coupled to the second side 117 and the first side 116 includes a first end 105a that is electrically connected to a first contact (not shown) in a receptacle and a second end 106a that is electrically connected to a second contact (not shown) in a receptacle and the first and second end 105a, 106a are joined at a centertap node 107a. The first and second contacts could be contacts as are commonly found in an RJ45 receptacle (e.g., pair ½ or 3/6 or ⅘ or ⅞). A second transformer 115b similarly includes the first side that includes a first end 105b, a second end 105b and a centertap node 107b and could be connected to a different pair.

An avalanche diode 145 electrically connects the centertap node 107a to the centertap node 107b. Typically a capacitor would also be positioned between the two centertaps to provide electrical transient suppression. However, as depicted a first capacitor 140a and a second capacitor 140b (which can have substantially the same values) are positioned in series between the two centertap nodes 107a/107b in parallel with the avalanche diode 145. Between the two capacitors 140a, 140b is a sub node 155 that is electrically connected to a first side 130a of a resistor 130. As can be appreciated, the resistor 130 can he formed of multiple physically discrete components that will act together to form a single resistor (parallel resistors will divide the current, serial resistors will increase the impedance) and thus the resistor is not limited to a single discrete component but instead may be provided by joining an array of discrete components in a cost effective manner. A second side 130b of the resistor 130 is connected to a common node 133 with is connected to a second resistor and is also connected to a safety capacitor 135, which can be a 2000 volt capacitor configured to provide electrical isolation from ground 110. Power can be provided (so as to provide POE functionality) by applying a voltage across node 122a and node 122b. The power provided via the application of a voltage across the nodes 122a, 122b can he passed through a filter 150.

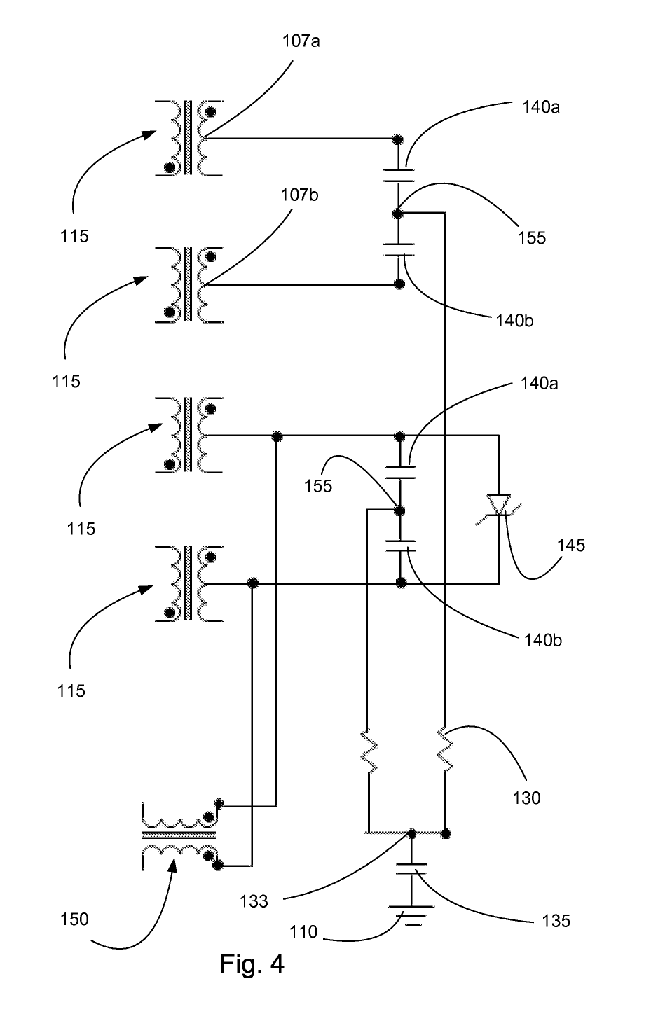

FIG. 4 illustrates an embodiment of a schematic of a connector with power only being provided across two pairs of wires. As can be appreciated, centertap 107a of a first side of a first transformer 115 is connected to a first side of a capacitor 140a while centertap 107b of a first side of a second transformer 115 is connected to a first side of capacitor 140b, The second sides of these capacitors 140a, 140b is connected to a sub node 155. The sub node 155 is connected to a first side of a resistor 130 and a second side of the resistor 130 is connected to a common node 133 which is in turn is connected to a safety capacitor 135. The safety capacitor 135 is positioned, electrically speaking, between the common node 133 and ground 110. Thus, FIG. 4 provides a comparable construction as disclosed in FIG. 3 except that only two pairs of lines are used to provide POE. As can be appreciated, therefore, the load circuit disclosed herein can thus be used for POE circuits as well as non-POE circuits. For example, if desired the POE portion of FIG. 4 could be removed so that the schematic only depicted a non-POE design. In such a configuration the avalanche diode 145 feature could be omitted, as would the filter 150.

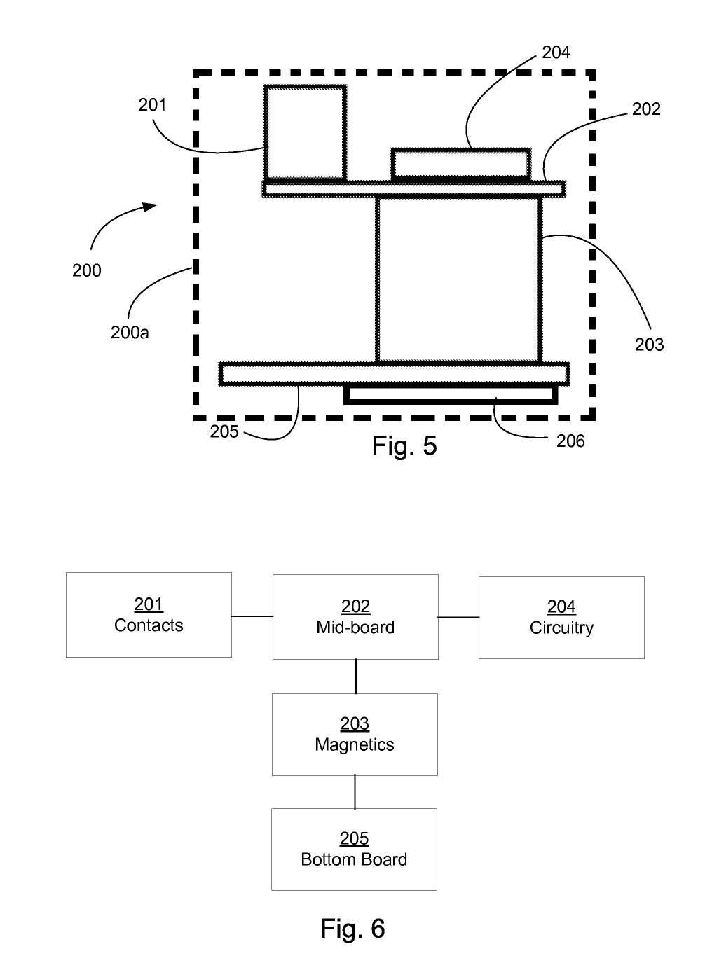

FIGS. 5 and 6 illustrate a schematic/block diagram representations of a potential port configuration. A port 200, such as an RJ45 port, is defined by a housing 200a (shown in broken line) that supports contacts 201. The contacts 201 are coupled to a mid-board 202, which could support the circuitry 204, which could include the load circuit depicted in FIG. 3 or FIG. 4 (or a non-POE load circuit based on a modified version of the circuit depicted in FIG. 4). Magnetics 203 (e.g., the transformers) are provided to magnetically couple the contacts 201 to bottom contacts 206 that engage/extend from the bottom board 205. It should be noted that while a bottom board 205 is depicted, such a construction is not required and other structures can be used to support the bottom contacts 206, thus the use of the bottom board 205 is not intended to be limiting but instead is representative of a suitable construction. As can be appreciated, the schematically depicted system of FIG. 5 could readily be configured to provide both an upper port and a lower port and in practice it is common for the housing 200a and the other components to be configured to support two ports. Thus the circuitry 204 supported by a mid-board 202 could be doubled so that the appropriate electrical support for the two ports was provided.

It should be noted that most current systems use 8 contacts, thus the contacts 201 typically will include 4 pairs of contacts. The depicted load circuit will also work with just two pairs of contacts and thus the number of contacts is not intended to be limited but instead is representative of the typical configuration.

As can be appreciated, one significant advantage of the depicted design is that it allows the component cost of a POE-enabled circuit to be reduced. Given that it is expected a larger percentage of ports will be configured to provide POE, the depicted circuitry can provide a desirable cost saving.

The disclosure provided herein describes features in terms of preferred and exemplary embodiments thereof. Numerous other embodiments, modifications and variations within the scope and spirit of the disclosure will occur to persons of ordinary skill in the art from a review of this disclosure.

I claim:

1. A connector, comprising:
a housing that defines a port, the housing including a first pair of contacts and a second pair of contacts, a mid-board and a first pair of bottom contacts and a second pair of bottom contacts;
a first transformer magnetically coupling the first pair of contacts with the first pair of bottom contacts;
a second transformer magnetically coupling the second pair of contacts with the second pair of bottom contacts;
a first centertap electrically connected o the first pair of contacts and electrically connected to a first sub-node;
a second centertap electrically connected to the second pair of contacts and electrically connector to a second sub-node;
a first capacitor having a first end and a second end, the first end connected to the first sub-node and the second end connected to a common node;
a second capacitor having a first end and a second end, the first end connected to the second sub-node and the second end connected to the common node; and
a resistor with a first end connected to the common node and a second end connected to a ground plane via a safety capacitor.

2. The connector of claim 1, further comprising an avalanche diode connecting the first sub-node to the second sub-node and a first voltage input to the first sub-node and a second voltage input to the second sub-node.

3. The connector of claim 2, further comprising a common-mode choke coupled to the first and second voltage inputs.

4. The connector of claim 1, wherein the common node is a first common node, the port further comprising:
a third pair of contacts and a fourth pair of contacts and a third pair of bottom contacts and a fourth pair of bottom contacts:
a third transformer magnetically coupling the third pair of contacts with the third pair of bottom contacts;
a fourth transformer magnetically coupling the fourth air of contacts with the fourth pair of bottom contacts;
a third centertap electrically connected to the third pair of contacts and electrically connected to a third sub-node;
a fourth centertap electrically connected to the fourth pair of contacts and electrically connector to a fourth sub-node;
a third capacitor having a first end and a second end, the first end connected to the third sub-node and the second end connected to a second common node;
a second capacitor having a first end and a second end, the first end connected to the second sub-node and the second end connected to the second node; and
a second resistor with a first end connected to the second common node and a second end connected to a ground plane via a safety capacitor, wherein the resistor and the second resistor.

5. The connector of claim 4, wherein the third sub-node and the fourth sub-node are not connected by an avalanche diode.

6. A connector, comprising:
a housing that defines a port, the housing including a first pair of contacts and a second pair of contacts, a mid-board and a first pair of bottom contacts and a second pair of bottom contacts;
a first transformer magnetically coupling the first pair of contacts with the first pair of bottom contacts;
a second transformer magnetically coupling the second pair of contacts with the second pair of bottom contacts;
a first centertap connected to the first pair of contacts and electrically connected to a first sub-node;
a second centertap connected to the second pair of contacts and electrically connector to a second sub-node;
a first capacitor having a first end and a second end, the first end connected to the first sub-node and the second end connector to a first common node;
a second capacitor having a first end and a second end, the first end connected to the second sub-node and the second end connected to the first common node; and
a first resistor with a first end connected to the first common node and a second end connected to a ground plane via a safety capacitor.

7. The connector of claim 6, the port further comprising:
a third pair of contacts and a fourth pair of contacts positioned in the port and a third pair of bottom contacts and a fourth pair of bottom contacts;
a third transformer magnetically coupling the third pair of contacts with the third pair of bottom contacts;
a fourth transformer magnetically coupling the fourth pair of contacts with the fourth pair of bottom contacts;
a third centertap electrically connected to the third pair of contacts and electrically connected to a third sub-node;
a fourth centertap electrically connected to the fourth pair of contacts and electrically connector to a fourth sub-node;
a third capacitor having a first end and a second end, the first end connected to the third sub-node and the second end connected to a second common node;
a second capacitor having a first end and a second end, the first end connected to the second sub-node and the second end connected to the second node; and
a second resistor with a first end connected to the second common node and a second end connected to the ground plane via the safety capacitor, wherein the second end of the resistor and the second end of the second resistor are electrically common.

8. The connector of claim 7, wherein there is at least one avalanche diode positioned between one of the first and second sub-nodes and the third and fourth sub-nodes.
